(19) United States
(12) Patent Application Publication
(10) Pub. No.: US 2025/0335569 A1
(43) Pub. Date: Oct. 30, 2025

(54) ADAPTIVE AND DESIGN-AGNOSTIC ACTIVE WATERMARKING FOR AUTHENTICATION OF HARDWARE INTELLECTUAL PROPERTY (IP) CORE OWNERSHIP

(71) Applicant: University of Research Foundation, Incorporated, Gainesville, FL (US)

(72) Inventors: Farimah Farahmandi, Gainesville, FL (US); Zahin Ibnat, Gainesville, FL (US); Mark Tehranipoor, Gainesville, FL (US); Mohammad Sazadur Rahman, Gainesville, FL (US); Hadi Mardani Kamali, Gainesville, FL (US); Mridha Md Mashahedur Rahman, Gainesville, FL (US)

(21) Appl. No.: 19/188,521

(22) Filed: Apr. 24, 2025

Related U.S. Application Data
(60) Provisional application No. 63/638,616, filed on Apr. 25, 2024.

(51) Int. Cl. G06F 21/44; G06F 21/72

(52) U.S. Cl. CPC G06F 21/44; G06F 21/72; G06F 2221/2103

(57) ABSTRACT

Various embodiments of the present disclosure provide adaptive and design-agnostic active watermarking for authentication of a circuit. In one example, an embodiment provides for transmitting a challenge prompt to respective peripherals of an integrated circuit, receiving a peripheral response from the respective peripherals in response to the challenge prompt, and authenticating one or more functionalities of the integrated circuit based on the peripheral response from the respective peripherals.

### CROSS REFERENCE TO RELATED APPLICATIONS

This application claims priority to U.S. Appl. No. 63/638,616 filed Apr. 25, 2024, the contents of which are incorporated herein in its entirety by reference.

### GOVERNMENT SUPPORT

This invention was made with government support under Agreement No. HR 0011-20-9-0043, awarded by US DEPT OF DEFENSE DARPA. The government has certain rights in the invention.

### TECHNICAL FIELD

The present application relates to the technical field of hardware security for integrated circuits. In particular, the invention relates to watermarking for integrated circuits.

### BACKGROUND

Hardware cores are commonly employed in the semiconductor industry. Furthermore, a single System on Chip (SoC) generally comprises one or more third-party semiconductor cores such as one or more hardware Intellectual Property (IP) cores. A hardware IP core is typically comprised of Register Transfer Level (RTL) source code and/or one or more gate-level netlists. However, hardware IP cores are generally vulnerable to security concerns such as IP piracy, counterfeiting, reverse engineering, etc. As such, an IP protection technique such as, for example, an authentication technique, can be employed to provide IP protection. Authentication techniques such as, for example, watermarking generally rely on insertion of a unique signature (e.g., a watermark) to prove ownership of a hardware IP core. As such, watermarking typically offers a viable solution to combat IP piracy and illegal re-use of hardware IP cores. However, watermarking verification techniques typically rely heavily on manual testing by a human and are prone to certain types of security vulnerabilities such as, for example, a rogue SoC design house that designs and/or develops SoCs.

### SUMMARY

In general, embodiments of the present invention provide methods, apparatus, systems, computing devices, computing entities, and/or the like for providing adaptive and design-agnostic active watermarking for authentication of a circuit. The details of some embodiments of the subject matter described in this specification are set forth in the accompanying drawings and the description below. Other features, aspects, and advantages of the subject matter will become apparent from the description, the drawings, and the claims.

In an embodiment, a method for providing active watermarking associated with an integrated circuit is provided. The method provides for transmitting a challenge prompt to respective peripherals of an integrated circuit, receiving a peripheral response from the respective peripherals in response to the challenge prompt, and/or authenticating one or more functionalities of the integrated circuit based on the peripheral response from the respective peripherals.

In another embodiment, an apparatus for providing a functional verification flow of obfuscated designs for circuits is provided. The apparatus comprises at least one processor and at least one memory including program code. The at least one memory and the program code is configured to, with the at least one processor, cause the apparatus to transmit a challenge prompt to respective peripherals of an integrated circuit, receive a peripheral response from the respective peripherals in response to the challenge prompt, and/or authenticate one or more functionalities of the integrated circuit based on the peripheral response from the respective peripherals.

In yet another embodiment, a non-transitory computer storage medium comprising instructions for providing a functional verification flow of obfuscated designs for circuits is provided. The instructions are configured to cause one or more processors to at least perform operations configured to transmit a challenge prompt to respective peripherals of an integrated circuit, receive a peripheral response from the respective peripherals in response to the challenge prompt, and/or authenticate one or more functionalities of the integrated circuit based on the peripheral response from the respective peripherals.

### BRIEF DESCRIPTION OF THE DRAWINGS

Reference will now be made to the accompanying drawings, which are not necessarily drawn to scale, and wherein:

FIG. 1 provides an example circuit design flow for watermarking and circuit peripheral verification, according to one or more embodiments of the present disclosure;

FIG. 2 provides another example circuit design flow for watermarking and circuit peripheral verification, according to one or more embodiments of the present disclosure;

FIG. 3 illustrates an example verification process framework, according to one or more embodiments of the present disclosure;

FIG. 4 illustrates an example pinging verification framework, according to one or more embodiments of the present disclosure.

FIG. 5 illustrates example circuits with a watermarked intellectual property (IP) and one or more peripherals, according to one or more embodiments of the present disclosure;

FIG. 6 illustrates various improvements for a circuit by utilizing a watermarking technique, according to one or more embodiments of the present disclosure;

FIG. 7 illustrates a flowchart of a method for providing adaptive and design-agnostic active watermarking for authentication of a circuit according to one or more embodiments of the present disclosure;

FIG. 8 illustrates a flowchart of a method for providing adaptive and design-agnostic active watermarking for authentication of a circuit according to one or more embodiments of the present disclosure;

FIG. 9 illustrates a flowchart of a method for providing adaptive and design-agnostic active watermarking for authentication of a circuit according to one or more embodiments of the present disclosure; and

FIG. 10 illustrates a schematic of a computing entity that may be used in conjunction with one or more embodiments of the present disclosure.

### DETAILED DESCRIPTION

The present disclosure more fully describes various embodiments with reference to the accompanying drawings. It should be understood that some, but not all, embodiments are shown and described herein. Indeed, the embodiments may take many different forms, and, accordingly, this disclosure should not be construed as limited to the embodiments set forth herein. Rather, these embodiments are provided so that this disclosure will satisfy applicable legal requirements. Like numbers refer to like elements throughout.

As discussed above, hardware cores are commonly employed in the semiconductor industry. Furthermore, a single System on Chip (SoC) generally comprises one or more third-party semiconductor cores such as one or more hardware Intellectual Property (IP) cores. A hardware IP core is typically comprised of Register Transfer Level (RTL) source code and/or one or more gate-level netlists. Additionally, SoCs are becoming ever-increasingly complex as SoCs support more functionalities for addressing the demand for more advanced technologies. In such circumstances, SoC design teams commonly license pre-designed hardware IP cores as soft (e.g., RTLs), hard (e.g., GDSIIs), or firm (e.g., netlists) IP cores. Additionally, to maintain cutting-edge semiconductor fabrication more affordable, fabless semiconductor companies typically out-source post-silicon stages (e.g., fabrication, testing, and/or packaging) to offshore foundries. However, as the IP rights owner may provide the SoC integrator (and foundry) with the entire specification, the IP owners are no longer the sole proprietor of content, resulting in increased security vulnerabilities for the hardware such as, for example, IP theft, counterfeiting, reverse engineering, integrated circuit overproduction, etc. As such, an IP protection technique such as, for example, an authentication technique, can be employed to provide IP protection. Authentication techniques such as, for example, watermarking generally rely on insertion of a unique signature (e.g., a watermark) to prove ownership of a hardware IP core.

Watermarking embeds a unique signature into a hardware IP core (e.g., building the watermarked IP) in a way that does not alter original functionality of the hardware. Accordingly, when the hardware IP core is ready for fabrication, the IP owner can retain the IP and extract its signature using the activation parameters created to prove the legitimate use of the hardware IP core in the SoC by comparing it with the initially embedded signature. Ideally, watermarking should be easy to embed and/or verify. In this regard, a watermarking technique is typically configured within a watermarking category such as constraint-based watermarking, Digital signal processing (DSP) based watermarking, Finite state machines (FSM) based watermarking, test structures based watermarking, or a side-channels based watermarking.

As such, watermarking typically offers a viable solution to combat IP piracy and illegal re-use of hardware IP cores. However, watermarking verification techniques typically rely heavily on manual testing by a human and are prone to certain types of security vulnerabilities such as, for example, a rogue SoC design house that designs and/or develops SoCs. Additionally, IP watermarks are typically considered passive since they do not prevent IP theft. For example, a watermarked hardware IP core remains functional even if stolen and used on a different system. As such, it is only possible for IP owners to prove authorship if the IP owner has access to the IP in the SoC. As an example, when a rogue SoC integrator pirates a hardware IP core without any contract with the IP owner, they restrict (e.g., block) direct access to the IP. In this case, only the inputs/outputs of the integrated circuit are available for proving ownership of the IP (e.g., not the I/O of the IP), enabling the rogue integrator to use the IP illegally in different integrated circuits. Existing watermarking techniques therefore do not explicitly address the extraction of watermarks in such cases. As another example, an IP owner may extract a watermarking signature if the signature is side-channel based. However, techniques such as FSMs and test structures may be unable to sufficiently prevent an attack since the attacker may block the observability of the hardware IP core. As such, IP theft may be effectively deterred if the embedding watermark signature is active (e.g., prevented IP piracy or changed IP functionality).

To address these and/or other issues, various embodiments described herein relate to adaptive and design-agnostic active watermarking for authentication of hardware IP core ownership. In various embodiments, to automate the watermarking-based verification process and to improve resiliency against various security vulnerabilities (e.g., a rogue design house), an automatic self-verification technique can be conducted by communicating with various peripherals within a circuit (e.g., various peripherals within an SoC). In various embodiments, the watermarking techniques disclosed herein can be IP/SoC-agnostic to further improve resiliency against removal and spoofing attacks. Additionally, he watermarking techniques disclosed herein can be an active watermarking technique that consider a rogue SoC integrator as a primary perpetrator who can pirate the IP from an SoC in order to reuse the IP in a different SoC (e.g., without a contract, license, or other permission) and make the IP inoperable if successfully integrated into an illegitimate SoC. The active watermarking technique disclosed herein can be implemented without direct access to the watermarked IP for ownership proof. In various embodiments, the watermarking techniques disclosed herein can utilize specific challenge-response pairs (CRPs) acquired from neighboring SoC peripherals. As such, a fully automated verification process with no intervention from the IP owner can be provided. In various embodiments, a verification process based on inter-peripheral handshaking can be provided via one or more of the watermarking techniques disclosed herein. In various embodiments, a watermarked hardware IP core can be configured as dysfunctional in response to a failure of a watermark verification process. With the watermarking techniques disclosed herein, performance, power, and/or area (PPA) overhead of a hardware IP core can be adequately maintained as compared to hardware IP core without watermarking.

### A. EXAMPLE ACTIVE WATERMARKING OF VARIOUS EMBODIMENTS

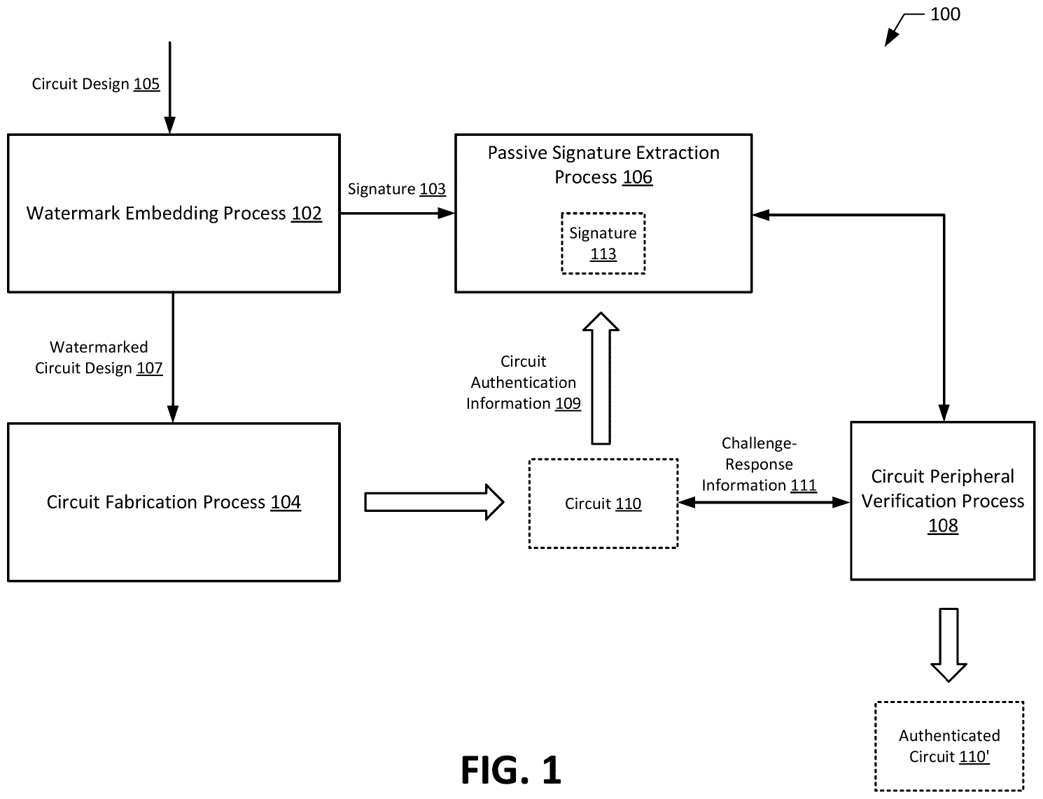

An example circuit design flow 100 for watermarking and circuit peripheral verification is shown in FIG. 1, according to one or more embodiments of the present disclosure. The circuit design flow 100 can be provided for a circuit 110. The circuit 110 can be an integrated circuit, a hardware IP core, an SoC that includes one or more hardware IP cores, a Network-on-Chip (NoC), or another type of circuit. In one or more embodiments, the circuit design flow 100 includes a watermark embedding process 102, a circuit fabrication process 104, a passive signature extraction process 106, and a circuit peripheral verification process 108.

In one or more embodiments, a circuit design 105 for the circuit 110 is utilized by the watermark embedding process 102 to provide watermarked circuit design 107 for the circuit 110. For example, the watermark embedding process 102 can perform embedding of a signature 103 into the circuit design 105 to provide the watermarked circuit design 107. The circuit design 105 can include an original IP design for the circuit 110. In some embodiments, the circuit design 105 can include Register Transfer Level (RTL) source code and/or one or more gate-level netlists for the circuit 110. The RTL source code can provide a high-level description of the circuit 110. For example, the RTL source code can model the circuit 110 based on flow of signals between hardware components and/or logical operations associated with the signals. In some embodiments, a hardware description language can be employed to implement the RTL source code. In some embodiments, the circuit design 105 can be generated based on a technology library. For example, the technology library can include a collection of logic gates and/or logic gate characteristics that can be employed to generate the circuit design 105 for the circuit 110. In some embodiments, the circuit design 105 can correspond to a single original IP design for the circuit 110. In some embodiments, the circuit design 105 can correspond to multiple original IP designs for the circuit 110.

The signature 103 that is embedded into the circuit design 105 can be a unique watermark for the circuit design 105. For example, the signature 103 can be a unique function within an IP core that does not affect original design functionality of the circuit design 105. The signature 103 can also be used to authenticate IP ownership. For example, the signature 103 can be utilized to identify ownership, an origin, and/or proper design of the circuit design 105. In some embodiments, the watermark embedding process 102 can utilize a watermarking technique such as constraint-based watermarking, DSP based watermarking, FSM based watermarking, test structures based watermarking, or a side-channels based watermarking to embed the signature 103 into the circuit design 105 to provide the watermarked circuit design 107.

The circuit fabrication process 104 can include one or more steps related to design, development, and/or fabrication of the circuit 110 based on the watermarked circuit design 107. In some embodiments, the circuit fabrication process 104 can be associated with one or more processes related to a semiconductor supply chain (e.g., SoC integrators, design service providers, offshore foundries, and/or test facilities) to enable design, development, and/or fabrication of the circuit 110 based on the watermarked circuit design 107. Additionally, the circuit fabrication process 104 may be associated with an adversary space that is prone to adversarial involvement with respect to design, development, and/or fabrication of the circuit 110 associated with the circuit design 105′. For example, the circuit fabrication process 104 may be prone to increased security vulnerabilities for the circuit 110 such as, for example, IP theft, counterfeiting, reverse engineering, integrated circuit overproduction, etc. during design, development, and/or fabrication of the circuit 110.

To provide resiliency against various security vulnerabilities for the circuit 110 during the circuit fabrication process 104, the passive signature extraction process 106 can perform extraction of a signature 113 from circuit authentication information 109 associated with the circuit 110. The circuit authentication information 109 can include circuit design information associated with the circuit 110. For example, the circuit authentication information 109 can include circuit behavior information associated with operation of the circuit 110, power consumption information associated with operation of the circuit 110, electromagnetic emissions information associated with operation of the circuit 110, timing characteristics associated with operation of the circuit 110, operational pattern information associated with multiple operation cycles of the circuit 110, signal analysis information associated with input signals and/or output signals of the circuit 110 during operation of the circuit 110, thermal analysis information associated with operation of the circuit 110, physical inspection information associated with the circuit 110, reverse engineering information associated with the circuit 110, and/or other circuit authentication information 109 associated with the circuit 110. Additionally, the passive signature extraction process 106 can compare the extracted signature 113 to the signature 103 embedded in the watermarked circuit design 107.

To improve resiliency against various security vulnerabilities for the circuit 110 during the circuit fabrication process 104, the circuit peripheral verification process 108 can communicate with one or more peripherals within the circuit 110 to facilitate verification of the circuit 110. In various embodiments, the circuit peripheral verification process 108 can be initiated in response to boot-up (e.g., starting an operating system or other application) of the circuit 110. For example, the circuit peripheral verification process 108 can be initiated in response to the circuit 110 being powered on, one or more hardware components of the circuit 110 being initialized during a boot mode, one or more memory regions of the circuit 110 being initialized, and/or one or more computer-executable instructions of the circuit 110 being executed. In various embodiments, the circuit peripheral verification process 108 can implement active verification of the peripherals to facilitate automatic self-verification of the circuit 110. For example, the circuit peripheral verification process 108 can utilize IP-level FSM watermarking verification where the circuit 110 associated with the watermarked circuit 105′ conducts communication with other circuit peripherals so that the circuit 110 can confirm that the circuit 110 is associated with the correct circuit design. In some embodiments, the circuit peripheral verification process 108 can utilize a serialized verification mechanism to enable sequential authentication of multiple independent watermarked IP portions within the circuit 110 to, for example, mitigate inter-IP verification conflicts during the circuit peripheral verification process 108. In some embodiments, authentication of the circuit 110 can be provided by utilizing the circuit peripheral verification process 108 without utilizing the passive signature extraction process 106. In some embodiments, authentication of the circuit 110 can be provided by utilizing both the circuit peripheral verification process 108 and the passive signature extraction process 106. The one or more peripherals within the circuit 110 can include one or more logic components, one or more decoders, one or more adders, one or more arithmetic logic units (ALUs), one or more cryptographic modules, one or more advanced encryption standard (AES) modules, one or more artificial intelligence accelerators, one or more neural network layers (e.g., one or more convolutional neural network layers, etc.), and/or one or more other types of peripheral components of the circuit 110.

In some embodiments, the circuit peripheral verification process 108 may communicate with the one or more peripherals within the circuit 110 to obtain challenge-response information 111 from the one or more peripherals. The challenge-response information 111 can include one or more challenge signals transmitted to the one or more peripherals of the circuit. The one or more challenge signals can be one or more challenge prompts that include an input signal and a memory address space for one or more data registers of a respective peripheral. The memory address space may be unique to a watermarking protocol associated with the watermarked circuit design 107. In some embodiments, the circuit peripheral verification process 108 can determine and/or generate the one or more challenge signals based on a FSM configured with a challenge-response algorithm for circuit peripheral verification. Additionally or alternatively, the challenge-response information 111 can include one or more response signals received from the one or more peripherals in response to the one or more challenge signals. The one or more response signals can include response data calculated by a respective peripheral using predefined functionality of the respective peripheral. In some embodiments, the circuit peripheral verification process 108 can compare an expected value of a response signal with a value included in a response signal provided by a respective peripheral. In some embodiments, the challenge-response information 111 can include challenge-response pairs (CRPs) for the one or more peripherals. In some embodiments, the circuit peripheral verification process 108 may communicate with the one or more peripherals via a watermarked IP core of the circuit 110.

In various embodiments, the circuit peripherals can be communicated with via a pinging system consisting of addresses and request prompts unique to the watermark verification. In response to a determination that the correct responses to the requests sent to the respective peripherals are received for all peripherals of the circuit 110, the circuit peripheral verification process 108 can determine that the circuit 110 is an authenticated circuit 110′ without a security vulnerability. In some embodiments, in response to a determination that the correct responses to the requests sent to the respective peripherals are received for all peripherals of the circuit 110, the circuit peripheral verification process 108 can confirms that IP of the circuit 110 is located in the correct circuit and the circuit peripheral verification process 108 can render the circuit 110 usable. For example, once the circuit 110 associated with the watermarked circuit design 107 receives the correct responses to the requests sent to the peripherals, then the verification confirms that the IP is located in the correct circuit and confirms that the circuit 110 is the authenticated circuit 110′. As such, if the verification of the circuit 110 succeeds via the circuit peripheral verification process 108, the functionality of the circuit 110 can be unchanged as compared to the circuit design 105.

However, if at any point during the verification that an incorrect result is provided by a peripheral of the circuit 110 associated with the watermarked circuit design 107, the circuit peripheral verification process 108 can determine that the circuit 110 is associated with a security vulnerability. For example, if at any point during the verification that an incorrect result is provided by a peripheral of the circuit 110 associated with the watermarked circuit design 107 as the response in a CRP, then the circuit 110 enters a state in which it does not function correctly. Alternatively, if the verification fails, the original IP functionality can remain present within the circuit 110, but the verification failure can result in the circuit 110 entering a different mode of operation where the circuit 110 functions incorrectly. For example, the circuit peripheral verification process 108 can modify functionality of one or more portions of the circuit 110 in response to a determination, based on the challenge-response information 111, that the extracted signature 113 does not match the signature 103 for the watermarked circuit design 107. In various embodiments, the circuit peripheral verification process 108 can be performed without observing outputs of a FSM.

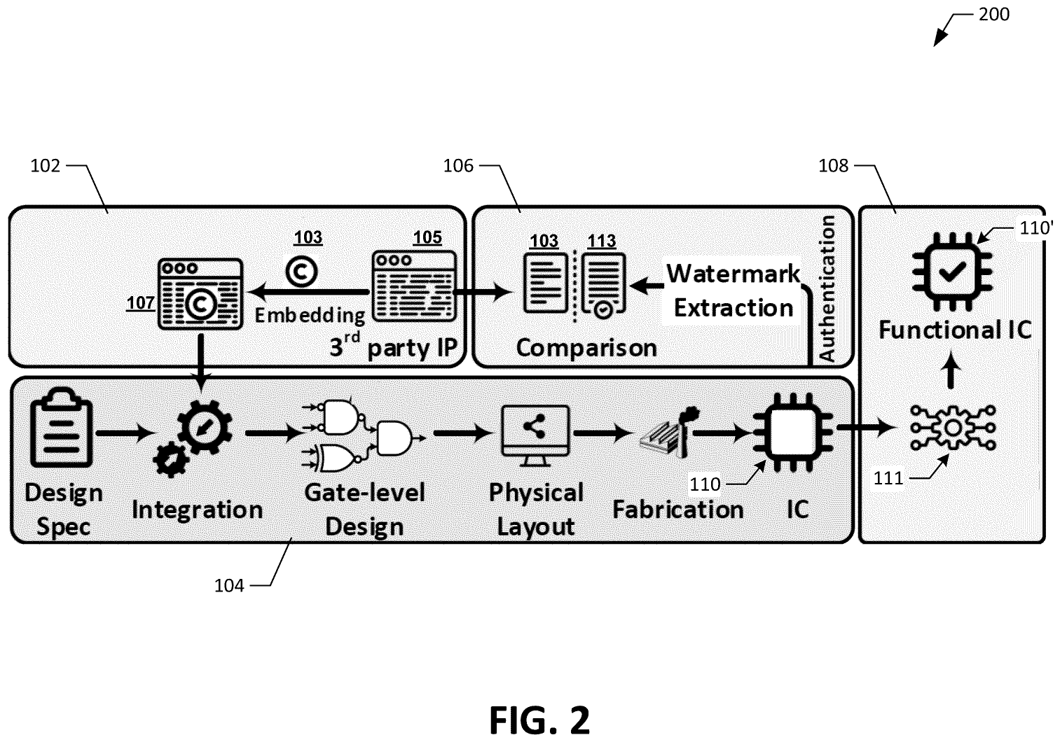

To further illustrate functionality associated with the watermark embedding process 102, the circuit fabrication process 104, the passive signature extraction process 106, and/or the circuit peripheral verification process 108, an example circuit design flow 200 for watermarking and circuit peripheral verification is shown in FIG. 2, according to one or more embodiments of the present disclosure. The circuit design flow 200 can be provided for the circuit 110. Additionally, the circuit design flow 200 can further illustrate one or more embodiments of the circuit design flow 100. In one or more embodiments, the circuit design flow 200 includes the watermark embedding process 102, the circuit fabrication process 104, the passive signature extraction process 106, and the SoC circuit peripheral verification process 108. The watermark embedding process 102 can perform embedding of the signature 103 into the circuit design 105 to provide the watermarked circuit design 107. The circuit fabrication process 104 can include one or more steps related to design, development, and/or fabrication of a circuit 110 based on the watermarked circuit design 107. The passive signature extraction process 106 can perform extraction of the signature 113 based on the circuit authentication information 109 associated with the circuit 110. Additionally, the passive signature extraction process 106 can compare the extracted signature 113 to the signature 103 embedded in the watermarked circuit design 107. The circuit peripheral verification process 108 can communicate with one or more peripherals within the circuit 110 to facilitate verification of the extracted signature 113.

In various embodiments, the circuit peripheral verification process 108 can communicate with the one or more peripherals within the circuit 110 to obtain the challenge-response information 111 from the one or more peripherals. Additionally, the circuit peripheral verification process 108 can authenticate one or more functionalities of the circuit 110 based on the signature 113 and the challenge-response information 111. For example, in response to a determination that the signature 113 matches the signature 103 and/or that the challenge-response information 111 matches expected challenge-response information for the circuit 110, the circuit peripheral verification process 108 can determine that the circuit 110 is successfully authenticated (e.g., the circuit peripheral verification process 108 can provide the authenticated circuit 110′). In some embodiments, the circuit peripheral verification process 108 may communicate with the one or more peripherals via a watermarked IP core of the circuit 110 to transmit and/or receive one or more portions of the challenge-response information 111. In some embodiments, the circuit peripheral verification process 108 can be performed to enable improved authentication of the circuit 110 without post-silicon signature extraction (e.g., without performing the passive signature extraction process 106).

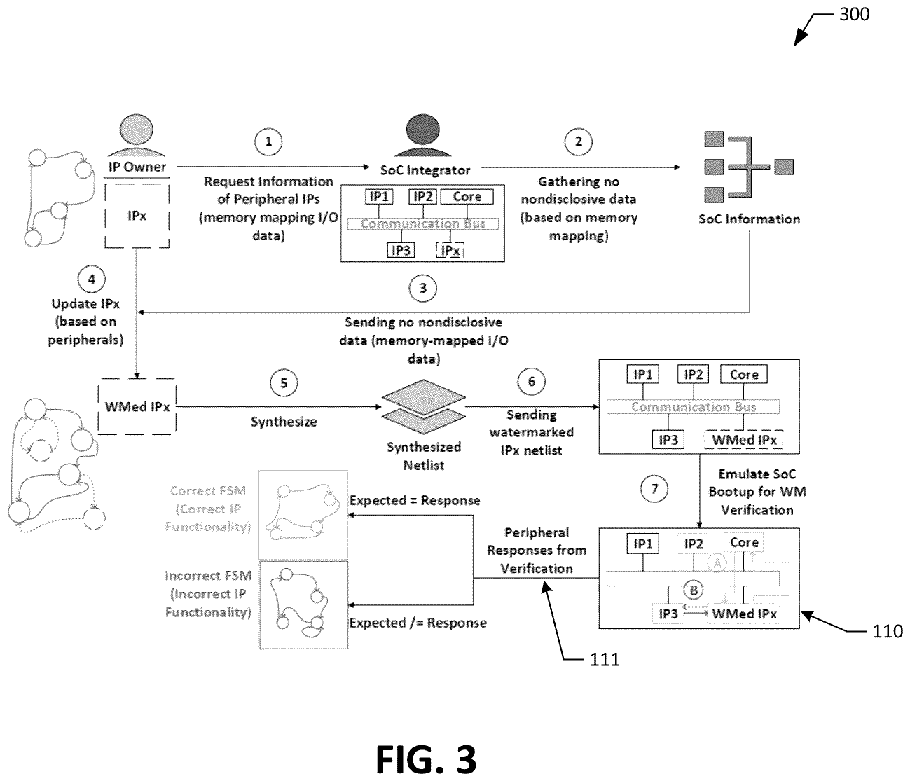

An example verification process framework 300 is shown in FIG. 3, according to one or more embodiments of the present disclosure. As illustrated in FIG. 3, an IP owner at step 1 requests information from a SoC integrator regarding the one or more peripherals of the circuit 110 and/or the physical mapping addresses within the circuit 110. It is to be appreciated that despite the particular threat model, the SoC integrator can see the IP owner as a threat because of this request for information about peripheral functionality and address spaces. Therefore, the SoC integrator may send this information to the IP owner, but the information will undergo garbling to enable a two-party secure computation. As for the functionality aspect for the IP owner, despite receiving information about a specific SoC, the watermark protocol may be SoC agnostic. After the IP owner receives this information, a number of peripherals are chosen at random to act as the points of communication for the watermark verification associated with the circuit peripheral verification process 108. Even though the peripherals are chosen at random, a time constraint can be utilized by the IP owner to minimize an amount of time and/or improve efficiency of the verification. At step 2, data based on a memory mapping associated with the one or more peripherals of the circuit 110 is determined. In some embodiments, the data may be utilized to generate at least a portion of the circuit design 105. At step 3, the memory mapped data is transmitted. At step 4, a netlist for the IP is updated based on the memory mapped data. Additionally, at step 5, the updated netlist is synthesized. The IP owner then sends the synthesized netlist at step 6 with the integrated watermark verification to the SoC integrator. In some embodiments, at least a portion of the watermarked circuit design 107 can correspond to the synthesized netlist. After the watermarked IP is placed within the SoC, the SoC goes through its own simulation at step 7 that emulates the bootup process, which initiates the watermark verification via the circuit peripheral verification process 108.

In some embodiments, responses from the one or more peripherals of the circuit 110 may be received via the challenge-response information 111. Additionally, the circuit peripheral verification process 108 may determine whether the respective responses from the one or more peripherals of the circuit 110 correspond to an expected response or an unexpected response. In some embodiments, the circuit peripheral verification process 108 may construct a FSM associated with IP-level FSM watermarking verification to determine whether the circuit 110 is associated with correct IP functionality or incorrect IP functionality.

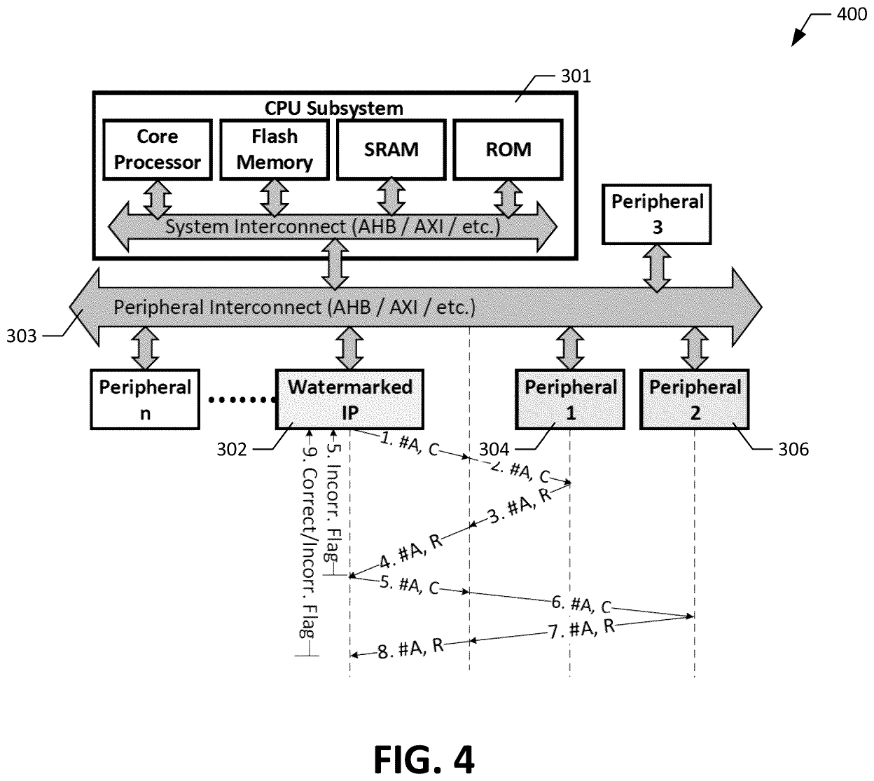

An example pinging verification framework 400 associated with a series of steps by which a watermarked IP communicates with circuit peripherals is shown in FIG. 4, according to one or more embodiments of the present disclosure. In some embodiments, the pinging verification framework 400 includes a framework of the circuit 110. For example, the circuit 110 can include at least a first peripheral 304, a next peripheral 306 and a watermarked IP 302. In some embodiments, the circuit 110 includes a CPU subsystem 301. The CPU subsystem 301 can include a core processor, flash memory, SRAM, ROM, and/or other hardware to enable functionality of the first peripheral 302, the next peripheral 306, and/or the watermarked IP 302. In some embodiments, the first peripheral 304, the next peripheral 306, the watermarked IP 302, and/or the CPU subsystem 301 can be communicatively coupled via a communication bus 303. In some embodiments, the circuit peripheral verification process 108 can be performed by the watermarked IP 302. As illustrated in FIG. 4, the watermarked IP 302 can perform a verification with an FSM as the watermarked IP 302 sets up a challenge prompt to the first peripheral 304 consisting of input signals and/or a memory address space for data registers of the first peripheral 304. The memory addresses used in verification can be unique and limited to the watermarking protocol. In some embodiments, the memory addresses can also be secret, but the memory addresses can exist within the defined address spaces of the circuit 110. The request is then sent via the communication bus 303 of the circuit 110. After receiving the prompt, the first peripheral 304 calculates a response using its preexisting functionality and sends a response back to the watermarked IP 302 via the communication bus 303. This exchange is denoted by A in step 7 illustrated in FIG. 3 and further illustrated in FIG. 4. Upon receiving the response, the watermarked IP 302 checks the information of the response with the expected value to the prompt. If the response matches the expected value calculated for the first peripheral 304, the verification continues to a next peripheral 306, which follows the same steps as with the first peripheral 304. In various embodiments, values of the expected response can be based on the functionality and specific inputs to the particular peripheral. Once, the response from the last peripheral is confirmed with the expected value, the watermarked IP 302 can end the verification process and enter a functional mode of the circuit 110. In various embodiments, a peripheral can be a decoder, an adder, an ALU, a cryptographic module such as a Rivest-Shamir-Adleman (RSA) component, an AES module, an artificial intelligence accelerator, a neural network layer (e.g., a convolutional neural network layers, etc.), or another type of peripheral component of the circuit 110. If at any point the verification fails, then the watermarked IP 302 can discontinue the verification and enter a mode where the circuit 110 functions incorrectly.

To further elaborate on each state of the protocols disclosed herein, the pinging verification framework 400 can depend first on an initial collaboration between the IP owner and the SoC integrator as seen in steps 1-4 illustrated in FIG. 3. For example, the IP owner typically desires to understand the available peripherals in the circuit and their functionality to develop a verification that depends on the communication between the IP and the peripherals. Moreover, steps 1-4 illustrated in FIG. 3 can act as an initial vetting process against an attacker. Accordingly, the pinging verification framework 400 can successfully act against a rogue SoC integrator and/or one or more security vulnerabilities such as removal attacks, forgery attacks, address collision or tampering, tampering and boolean satisfiability reverse engineering attacks, or another type of security vulnerability for a circuit. If the SoC integrator refuses to give the IP owner information regarding the peripherals within the SoC, this could mean that a security vulnerability is a rogue SoC integrator that does not want to share the addresses as well as CRPs to the IP owner. If the SoC integrator complies with the request for information from the IP owner, the integration of the watermark verification can proceed.

To provide an active watermarking process, the watermark protocol of the pinging verification framework 400 can be automated such that when the circuit 110 begins its own simulation, the watermarked IP 302 begins its verification to determine if it is placed in the correct circuit or not. This can be accomplished by integrating the watermark verification into a functional FSM of the watermarked IP 302. Additionally, the pinging verification framework 400 can be implemented without manual intervention. In various embodiments, when the verification succeeds for the first peripheral 304, a portion (e.g., half) of the functionality of the watermarked IP 302 can be made available. This can be thought of as part of the calculation towards the result of the IP is done after the initial part of the verification is done.

In various embodiments, the pinging verification framework 400 can utilize a communication protocol between the watermarked IP 302 and neighboring peripherals in the circuit 110. To establish this communication, SoC communication bus architectures can be utilized. In various embodiments, the communication bus 303 can send and receive data from all peripherals that make up the circuit 110. In various embodiments, the watermarked IP 302 can be configured as a master in the communication protocol so that it can send requests for data to the peripherals of the circuit 110. In various embodiments, the pinging verification framework 400 can be tailored to the communication protocol that exists in the circuit 110. Additionally, the pinging verification framework 400 can be bus agnostic such that any communication protocol can be applicable to the verification.

In various embodiments, the pinging verification framework 400 can utilize the communication protocol to send a request for data to the peripherals of the circuit 110 that are a part of the verification process. The request can include a unique address and/or an indication of the request. The address can be utilized by the communication bus so that the data reaches the correct peripheral. If the address of the request does not match that of a neighboring peripheral, the verification can fail, and the circuit 110 can be rendered functionally incorrect. However, if the address matches, then the request can be utilized for further verification. However, a simple acknowledgement may not be enough because the peripheral must match in functionality as well. In various embodiments, the response can be sent back through the communication bus 303 to the watermarked IP 302 so that the response can be matched to the expected value. In various embodiments, a response from more than one neighboring peripheral can be utilized where after the verification succeeds for one peripheral, the following peripheral's verification is triggered. Once all responses pass the verification, the watermarked IP 302 can be deemed fully confirmed. In certain embodiments, a location of the watermarked IP 302 in the circuit 110 can be deemed confirmed.

If the verification succeeds, the secure IP functions correctly within the circuit 110. Alternatively, if the verification does not succeed, then the IP functions incorrectly within the circuit 110. In various embodiments, the circuit 110 can be configured to provide incorrect responses rather than shutting off if the verification does not succeed to, for example, reduce likelihood that an attacker realizes that there is a verification process implemented via the IP. The rogue SoC integrator then cannot utilize the correct functionality of the IP, and the value of the insecure circuit can drop in the market since there is incorrect functionality present.

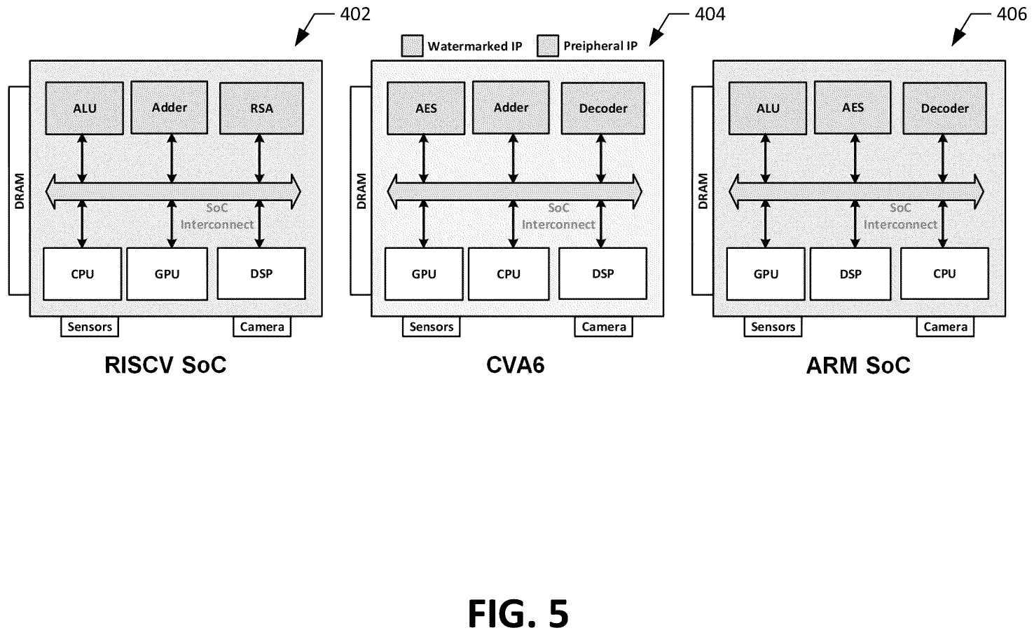

FIG. 5 illustrates example circuits with a watermarked IP and one or more peripherals, according to one or more embodiments of the present disclosure. For example, a circuit 402 can include an adder configured as a watermarked IP (e.g., the watermarked IP 302), an ALU configured as a first peripheral (e.g., the first peripheral 304), and a cryptographic module (e.g., an RSA component) configured as a second peripheral (e.g., the next peripheral 306). In another example, a circuit 404 can include an adder configured as a watermarked IP (e.g., the watermarked IP 302), an AES configured as a first peripheral (e.g., the first peripheral 304), and a decoder configured as a second peripheral (e.g., the next peripheral 306). In yet another example, a circuit 406 can include an AES configured as a watermarked IP (e.g., the watermarked IP 302), an ALU configured as a first peripheral (e.g., the first peripheral 304), and a decoder configured as a second peripheral (e.g., the next peripheral 306).

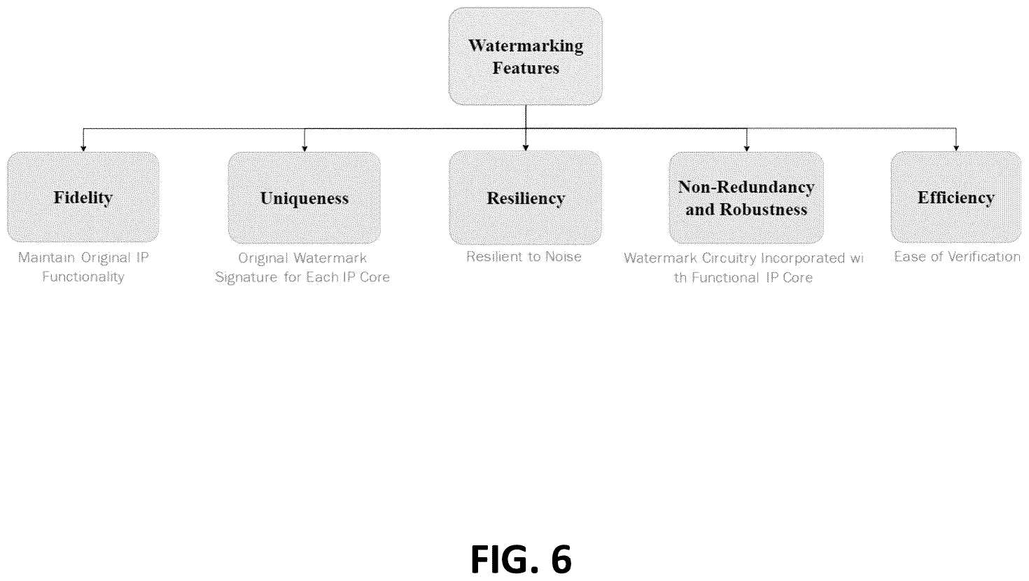

FIG. 6 illustrates various improvements for a circuit (e.g., the circuit 110) by utilizing a watermarking technique associated with adaptive and design-agnostic active watermarking for authentication of hardware IP core ownership, according to one or more embodiments of the present disclosure. For example, watermarking associated with the circuit design flow 100, the circuit design flow 200, the verification process framework 300, and/or the pinging verification framework 400 can provide various improvements such as, but not limited to improved fidelity for a circuit (e.g., the circuit 110), improved uniqueness for a circuit (e.g., the circuit 110), improved resiliency for a circuit (e.g., the circuit 110), non-redundancy and improved robustness for a circuit (e.g., the circuit 110), and/or improved efficiency for a circuit (e.g., the circuit 110).

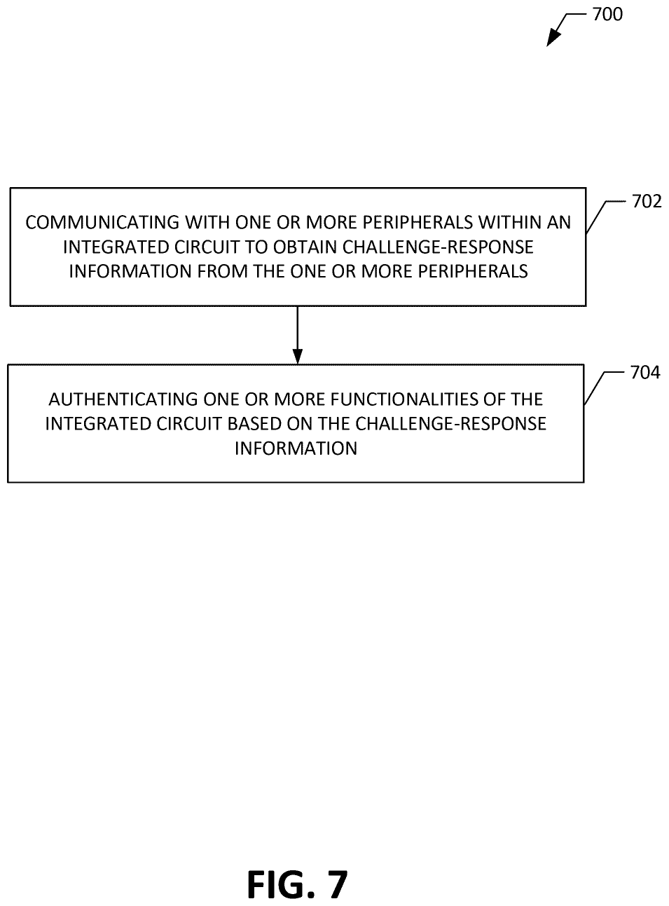

FIG. 7 illustrates a flowchart of a method 700 for providing adaptive and design-agnostic active watermarking for authentication of a circuit according to one or more embodiments of the present disclosure. According to the illustrated embodiment, the method 700 includes a step 702 for communicating with one or more peripherals within an integrated circuit to obtain challenge-response information from the one or more peripherals. In some embodiments, the one or more peripherals comprise a decoder, an adder, an ALU, a cryptographic module, an AES module, an artificial intelligence accelerator, or another type of peripheral component. Additionally, the method 700 includes a step 704 for authenticating one or more functionalities of the integrated circuit based on the challenge-response information.

In some embodiments, communicating with the one or more peripherals comprises transmitting, to a peripheral of the integrated circuit, an input signal associated with a memory address space for the peripheral.

In some embodiments, communicating with the one or more peripherals comprises transmitting a challenge prompt via an adder of the integrated circuit. In some embodiments, communicating with the one or more peripherals comprises transmitting the challenge prompt to an ALU of the integrated circuit. In some embodiments, communicating with the one or more peripherals comprises transmitting the challenge prompt to a cryptographic module of the integrated circuit. In some embodiments, communicating with the one or more peripherals comprises transmitting the challenge prompt to a decoder of the integrated circuit.

In some embodiments, communicating with the one or more peripherals comprises transmitting a challenge prompt via an AES module of the integrated circuit. In some embodiments, communicating with the one or more peripherals comprises transmitting the challenge prompt to an ALU of the integrated circuit. In some embodiments, communicating with the one or more peripherals comprises transmitting the challenge prompt to a decoder of the integrated circuit.

In some embodiments, the method 700 comprises modifying functionality of one or more portions of the integrated circuit in response to a determination that the challenge-response information does not match expected challenge-response information for the one or more peripherals.

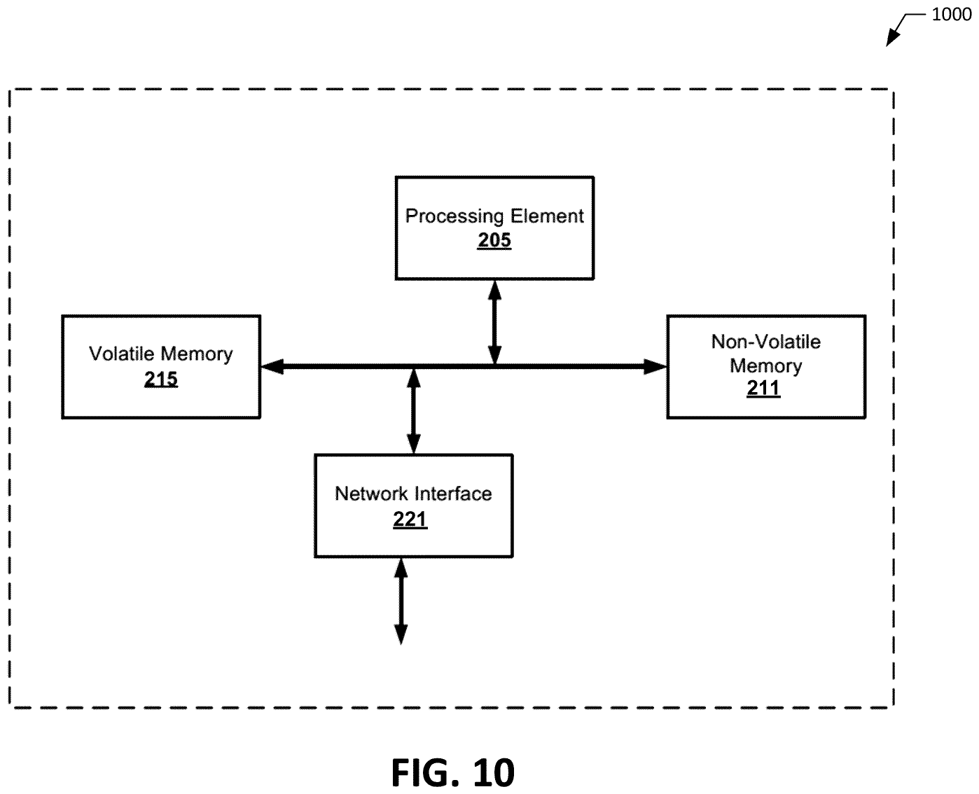

In an example embodiment, an apparatus for performing the method 700 of FIG. 7 above may include a processor configured to perform some or each of the steps (702, and/or 704) described above. The processor may, for example, be configured to perform the steps (702 and/or 704) by performing hardware implemented logical functions, executing stored instructions, or executing algorithms for performing each of the operations. Alternatively, the apparatus may comprise means for performing each of the operations described above. In this regard, according to an example embodiment, examples of means for performing steps 702 and/or 704 may comprise, for example, the processor and/or a device or circuit for executing instructions, executing operations, or executing an algorithm for processing information as described above. In various embodiments, an apparatus for performing the method 700 may correspond to apparatus 1000 illustrated in FIG. 10.

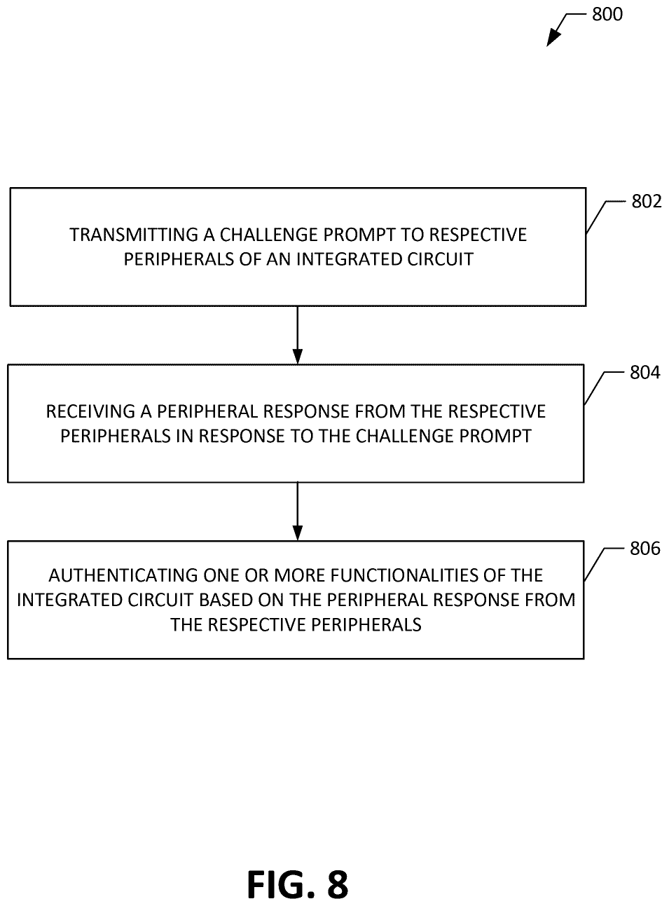

FIG. 8 illustrates a flowchart of a method 800 for providing adaptive and design-agnostic active watermarking for authentication of a circuit according to one or more embodiments of the present disclosure. According to the illustrated embodiment, the method 800 includes a step 802 for transmitting a challenge prompt to respective peripherals of an integrated circuit. In some embodiments, the respective peripherals comprise a decoder, an adder, an ALU, a cryptographic module, an AES module, an artificial intelligence accelerator, or another type of peripheral component. Additionally, the method 800 includes a step 804 for receiving a peripheral response from the respective peripherals in response to the challenge prompt. Additionally, the method 800 includes a step 806 for authenticating one or more functionalities of the integrated circuit based on the peripheral response from the respective peripherals.

In some embodiments, transmitting the challenge prompt comprises transmitting, to a peripheral of the integrated circuit, an input signal associated with a memory address space for the peripheral.

In some embodiments, transmitting the challenge prompt comprises transmitting the challenge prompt via an adder of the integrated circuit. In some embodiments, transmitting the challenge prompt comprises transmitting the challenge prompt to an ALU of the integrated circuit. In some embodiments, transmitting the challenge prompt comprises transmitting the challenge prompt to a cryptographic module of the integrated circuit. In some embodiments, transmitting the challenge prompt comprises transmitting the challenge prompt to a decoder of the integrated circuit.

In some embodiments, transmitting the challenge prompt comprises transmitting the challenge prompt via an AES module of the integrated circuit. In some embodiments, transmitting the challenge prompt comprises transmitting the challenge prompt to an ALU of the integrated circuit. In some embodiments, transmitting the challenge prompt comprises transmitting the challenge prompt to a decoder of the integrated circuit.

In some embodiments, the method 800 comprises modifying functionality of one or more portions of the integrated circuit in response to a determination that the peripheral response from the respective peripherals does not match an expected peripheral response for the respective peripherals.

In an example embodiment, an apparatus for performing the method 800 of FIG. 8 above may include a processor configured to perform some or each of the steps (802, 804 and/or 806) described above. The processor may, for example, be configured to perform the steps (802, 804 and/or 806) by performing hardware implemented logical functions, executing stored instructions, or executing algorithms for performing each of the operations. Alternatively, the apparatus may comprise means for performing each of the operations described above. In this regard, according to an example embodiment, examples of means for performing steps 802, 804 and/or 806 may comprise, for example, the processor and/or a device or circuit for executing instructions, executing operations, or executing an algorithm for processing information as described above. In various embodiments, an apparatus for performing the method 800 may correspond to apparatus 1000 illustrated in FIG. 10.

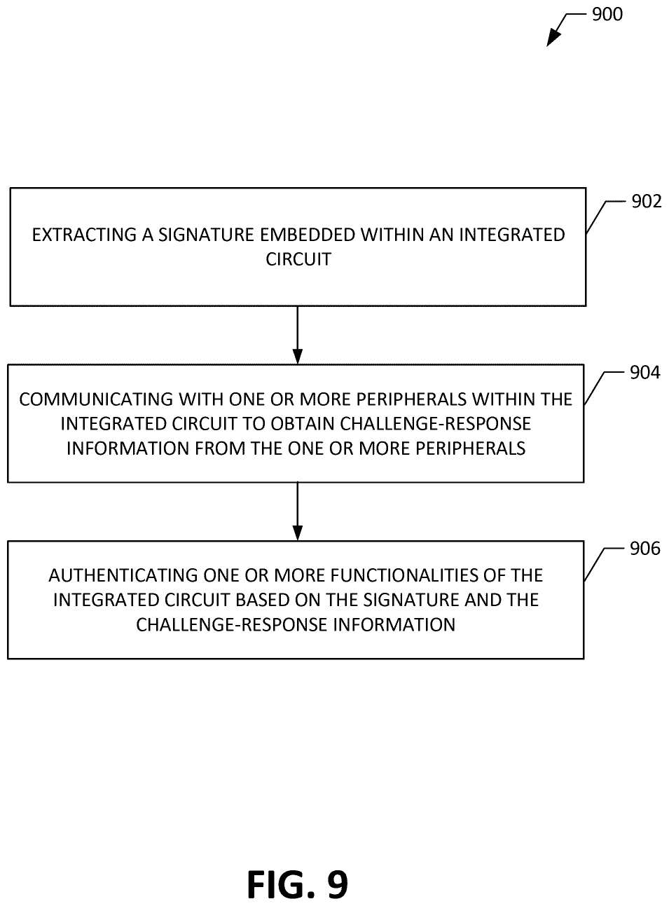

FIG. 9 illustrates a flowchart of a method 900 for providing adaptive and design-agnostic active watermarking for authentication of a circuit according to one or more embodiments of the present disclosure. According to the illustrated embodiment, the method 900 includes a step 902 for extracting a signature embedded within an integrated circuit. Additionally, the method 900 includes a step 904 for communicating with one or more peripherals within the integrated circuit to obtain challenge-response information from the one or more peripherals. In some embodiments, the one or more peripherals comprise a decoder, an adder, an ALU, a cryptographic module, an AES module, an artificial intelligence accelerator, or another type of peripheral component. Additionally, the method 900 includes a step 906 for authenticating one or more functionalities of the integrated circuit based on the signature and the challenge-response information.

In some embodiments, communicating with the one or more peripherals comprises transmitting, to a peripheral of the integrated circuit, an input signal associated with a memory address space for the peripheral.

In some embodiments, communicating with the one or more peripherals comprises transmitting a challenge prompt via an adder of the integrated circuit. In some embodiments, communicating with the one or more peripherals comprises transmitting the challenge prompt to an ALU of the integrated circuit. In some embodiments, communicating with the one or more peripherals comprises transmitting the challenge prompt to a cryptographic module of the integrated circuit. In some embodiments, communicating with the one or more peripherals comprises transmitting the challenge prompt to a decoder of the integrated circuit.

In some embodiments, communicating with the one or more peripherals comprises transmitting a challenge prompt via an AES module of the integrated circuit. In some embodiments, communicating with the one or more peripherals comprises transmitting the challenge prompt to an ALU of the integrated circuit. In some embodiments, communicating with the one or more peripherals comprises transmitting the challenge prompt to a decoder of the integrated circuit.

In some embodiments, the method 900 comprises modifying functionality of one or more portions of the integrated circuit in response to a determination that the challenge-response information does not match expected challenge-response information for the one or more peripherals.

In an example embodiment, an apparatus for performing the method 900 of FIG. 9 above may include a processor configured to perform some or each of the steps (902, 904 and/or 906) described above. The processor may, for example, be configured to perform the steps (902, 904 and/or 906) by performing hardware implemented logical functions, executing stored instructions, or executing algorithms for performing each of the operations. Alternatively, the apparatus may comprise means for performing each of the operations described above. In this regard, according to an example embodiment, examples of means for performing steps 902, 904 and/or 906 may comprise, for example, the processor and/or a device or circuit for executing instructions, executing operations, or executing an algorithm for processing information as described above. In various embodiments, an apparatus for performing the method 900 may correspond to apparatus 1000 illustrated in FIG. 10.

### B. EXAMPLE TECHNICAL IMPLEMENTATION OF VARIOUS EMBODIMENTS

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a hardware description language, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJ G RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

FIG. 10 provides a schematic of an example apparatus 1000 that may be used in accordance with various embodiments of the present disclosure. In particular, the apparatus 1000 may be configured to perform various example operations described herein to provide for adaptive and design-agnostic active watermarking for authentication of hardware IP core ownership. In one or more embodiments, the apparatus 1000 may be embodied by one or more portions of the circuit design flow 100, the circuit design flow 200, the verification process framework 300, and/or the pinging verification framework 400.

In general, the terms computing entity, entity, device, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

Although illustrated as a single computing entity, those of ordinary skill in the field should appreciate that the apparatus 1000 shown in FIG. 10 may be embodied as a plurality of computing entities, tools, and/or the like operating collectively to perform one or more processes, methods, and/or steps. As just one non-limiting example, the apparatus 1000 may comprise a plurality of individual data tools, each of which may perform specified tasks and/or processes.

Depending on the embodiment, the apparatus 1000 may include one or more network and/or communications interfaces 221 for communicating with various computing entities, such as by communicating data, content, information, and/or similar terms used herein interchangeably that can be transmitted, received, operated on, processed, displayed, stored, and/or the like. Thus, in certain embodiments, the apparatus 1000 may be configured to receive data from one or more data sources and/or devices as well as receive data indicative of input, for example, from a device.

The networks used for communicating may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks may have any suitable communication range associated therewith and may include, for example, global networks (e.g., the Internet), MANs, WANS, LANs, or PANs. In addition, the networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

Accordingly, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the apparatus 1000 may be configured to communicate via wireless external communication networks using any of a variety of protocols, such as general packet radio service (GPRS), Universal Mobile Telecommunications System (UMTS), Code Division Multiple Access 2000 (CDMA 2000), CDM A 2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), 5G New Radio (5G NR), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The apparatus 1000 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

In addition, in various embodiments, the apparatus 1000 includes or is in communication with one or more processing elements 205 (also referred to as processors, processing circuitry, and/or similar terms used herein interchangeably) that communicate with other elements within the apparatus 1000 via a bus, for example, or network connection. As will be understood, the processing element 205 may be embodied in several different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, ASICs, FPGA s, programmable logic arrays (PLA s), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware, computer program products, or a combination thereof, the processing element 205 may be capable of performing steps or operations according to embodiments of the present disclosure when configured accordingly.

In various embodiments, the apparatus 1000 may include or be in communication with non-volatile media (also referred to as non-volatile storage, memory, memory storage, memory circuitry and/or similar terms used herein interchangeably). For instance, the non-volatile storage or memory may include one or more non-volatile storage or non-volatile memory media 211 such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or non-volatile memory media 211 may store files, databases, database instances, database management system entities, images, data, applications, programs, program modules, scripts, source code, object code, byte code, compiled code, interpreted code, machine code, executable instructions, and/or the like. The term database, database instance, database management system entity, and/or similar terms used herein interchangeably and in a general sense refer to a structured or unstructured collection of information/data that is stored in a computer-readable storage medium.

In particular embodiments, the non-volatile memory media 211 may also be embodied as a data storage device or devices, as a separate database server or servers, or as a combination of data storage devices and separate database servers. Further, in some embodiments, the non-volatile memory media 211 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. As already discussed, various embodiments contemplated herein use data storage in which some or all the information/data required for various embodiments of the disclosure may be stored.

In various embodiments, the apparatus 1000 may further include or be in communication with volatile media (also referred to as volatile storage, memory, memory storage, memory circuitry and/or similar terms used herein interchangeably). For instance, the volatile storage or memory may also include one or more volatile storage or volatile memory media 215 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like.

As will be recognized, the volatile storage or volatile memory media 215 may be used to store at least portions of the databases, database instances, database management system entities, data, images, applications, programs, program modules, scripts, source code, object code, byte code, compiled code, interpreted code, machine code, executable instructions, and/or the like being executed by, for example, the processing element 205. Thus, the databases, database instances, database management system entities, data, images, applications, programs, program modules, scripts, source code, object code, byte code, compiled code, interpreted code, machine code, executable instructions, and/or the like may be used to control certain aspects of the operation of the apparatus 1000 with the assistance of the processing element 205 and operating system.

As will be appreciated, one or more of the computing entity's components may be located remotely from the other computing entity components, such as in a distributed system. Furthermore, one or more of the components may be aggregated, and additional components performing functions described herein may be included in the apparatus 1000. Thus, the apparatus 1000 can be adapted to accommodate a variety of needs and circumstances.

### C. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for providing active watermarking associated with an integrated circuit, the method comprising:
transmitting a challenge prompt to respective peripherals of an integrated circuit;
receiving a peripheral response from the respective peripherals in response to the challenge prompt; and
authenticating one or more functionalities of the integrated circuit based on the peripheral response from the respective peripherals.

2. The method of claim 1, further comprising:
modifying functionality of one or more portions of the integrated circuit in response to a determination that the peripheral response from the respective peripherals does not match an expected peripheral response for the respective peripherals.

3. The method of claim 1, wherein the respective peripherals comprise a decoder, an adder, an arithmetic logic unit (ALU), a cryptographic module, an advanced encryption standard (AES) module, an artificial intelligence accelerator, or another type of peripheral component.

4. The method of claim 1, wherein transmitting the challenge prompt comprises transmitting, to a peripheral of the integrated circuit, an input signal associated with a memory address space for the peripheral.

5. The method of claim 1, wherein transmitting the challenge prompt comprises transmitting the challenge prompt via an adder of the integrated circuit.

6. The method of claim 5, wherein transmitting the challenge prompt comprises transmitting the challenge prompt to an arithmetic logic unit (ALU) of the integrated circuit.

7. The method of claim 5, wherein transmitting the challenge prompt comprises transmitting the challenge prompt to a cryptographic module of the integrated circuit.

8. The method of claim 5, wherein transmitting the challenge prompt comprises transmitting the challenge prompt to a decoder of the integrated circuit.

9. The method of claim 1, wherein transmitting the challenge prompt comprises transmitting the challenge prompt via an advanced encryption standard (AES) module of the integrated circuit.

10. The method of claim 9, wherein transmitting the challenge prompt comprises transmitting the challenge prompt to an arithmetic logic unit (ALU) of the integrated circuit.

11. The method of claim 9, wherein transmitting the challenge prompt comprises transmitting the challenge prompt to a decoder of the integrated circuit.

12. An apparatus comprising at least one processor and at least one memory including program code, the at least one memory and the program code configured to, with the at least one processor, cause the apparatus to at least:
transmit a challenge prompt to respective peripherals of an integrated circuit;
receive a peripheral response from the respective peripherals in response to the challenge prompt; and
authenticate one or more functionalities of the integrated circuit based on the peripheral response from the respective peripherals.

13. The apparatus of claim 12, wherein the at least one memory and the program code are configured to, with the at least one processor, further cause the apparatus to at least:
modify functionality of one or more portions of the integrated circuit in response to a determination that the peripheral response from the respective peripherals does not match an expected peripheral response for the respective peripherals.

14. The apparatus of claim 12, wherein the respective peripherals comprise a decoder, an adder, an arithmetic logic unit (ALU), a cryptographic module, an advanced encryption standard (AES) module, an artificial intelligence accelerator, or another type of peripheral component.

15. The apparatus of claim 12, wherein the at least one memory and the program code are configured to, with the at least one processor, further cause the apparatus to at least:
transmit, to a peripheral of the integrated circuit, an input signal associated with a memory address space for the peripheral.

16. The apparatus of claim 12, wherein the at least one memory and the program code are configured to, with the at least one processor, further cause the apparatus to at least:
transmit the challenge prompt via an adder of the integrated circuit.

17. The apparatus of claim 16, wherein the at least one memory and the program code are configured to, with the at least one processor, further cause the apparatus to at least:
transmit the challenge prompt to an arithmetic logic unit (ALU) of the integrated circuit, a cryptographic module of the integrated circuit, or a decoder of the integrated circuit.

18. The apparatus of claim 12, wherein the at least one memory and the program code are configured to, with the at least one processor, further cause the apparatus to at least:
transmit the challenge prompt via an advanced encryption standard (AES) module of the integrated circuit.

19. The apparatus of claim 18, wherein the at least one memory and the program code are configured to, with the at least one processor, further cause the apparatus to at least:
transmit the challenge prompt to an arithmetic logic unit (ALU) of the integrated circuit or a decoder of the integrated circuit.

20. A non-transitory computer storage medium comprising instructions, the instructions being configured to cause one or more processors to at least perform operations configured to:
transmit a challenge prompt to respective peripherals of an integrated circuit;
receive a peripheral response from the respective peripherals in response to the challenge prompt; and
authenticate one or more functionalities of the integrated circuit based on the peripheral response from the respective peripherals.
